(19) United States
(12) Patent Application Publication
(10) Pub. No.: US 2025/0296824 A1
(43) Pub. Date: Sep. 25, 2025

(54) AUTOMATED DRIVING VEHICLE

(71) Applicant: KABUSHIKI KAISHA TOYOTA JIDOSHOKKI, Kariya-shi (JP)

(72) Inventors: Hirokazu KISHIDA, Kariya-shi (JP); Takaaki TAKENAKA, Kariya-shi (JP)

(73) Assignee: KABUSHIKI KAISHA TOYOTA JIDOSHOKKI, Kariya-shi (JP)

(21) Appl. No.: 19/068,563

(22) Filed: Mar. 3, 2025

(30) Foreign Application Priority Data
Mar. 21, 2024 (JP) 2024-045562

(51) Int. Cl. B66F 9/22; B66F 9/06

(52) U.S. Cl. CPC B66F 9/22; B66F 9/063

(57) ABSTRACT

An automated driving vehicle includes a hydraulic oil tank in which hydraulic oil is stored, a brake that generates braking force in accordance with pressure of hydraulic oil, a pump connected to the hydraulic oil tank, a motor that drives the pump, a controller that controls the motor, and a solenoid valve unit that includes an input port connected to an input oil passage connected to the pump and an output port connected to an output oil passage connected to the brake. The solenoid valve unit is switchable, based on a signal from the controller, between a connection state in which connection between the output port and the input port is not shut off and a checked state in which inflow of hydraulic oil from the output port to the input port is restricted while outflow of hydraulic oil from the input port to the output port is allowed.

### CROSS-REFERENCE TO RELATED APPLICATION

This application claims priority to Japanese Patent Application No. 2024-045562 filed on Mar. 21, 2024, the entire disclosure of which is incorporated herein by reference.

### BACKGROUND ART

The present disclosure relates to an automated driving vehicle.

Japanese Patent Application Publication No. 2020-164076 discloses a vehicle serving as an automated driving vehicle. The vehicle performs automated driving by using a vehicle control system. The vehicle includes a control device serving as a controller, a pressurizing/depressurizing device, and braking force applying device serving as a brake section. The control device includes a brake actuator control section that controls the pressurizing/depressurizing device. The pressurizing/depressurizing device includes a holding solenoid valve, a depressurizing solenoid valve, a cut valve, and a pump. The braking force applying device converts hydraulic pressure from brake oil serving as hydraulic oil into braking force that is applied to the wheel. The control device uses the brake actuator control section to control the holding solenoid valve, the depressurizing solenoid valve, and the cut valve, and to control the pump drive, thereby applying braking force to the wheel via the braking force applying device.

The pump is driven by a motor connected to the pump. As the frequency of deceleration and stopping increases in the vehicle, the time during which the pump is driven increases. During deceleration and stopping at a high frequency, a thermal load on the pump may increase. Furthermore, in Japanese Patent Application Publication No. 2020-164076, the controller controls the plurality of valves together with the pump to decelerate and stop the vehicle. In an automated driving vehicle that decelerates and stops by driving a pump, it is desirable to shorten the motor drive time for deceleration and stopping with a simple configuration.

### SUMMARY

In accordance with an aspect of the present disclosure, an automated driving vehicle includes a vehicle body, a hydraulic oil tank in which hydraulic oil is stored, a brake that generates braking force on a wheel of the vehicle body in accordance with pressure of the hydraulic oil, a pump connected to the hydraulic oil tank, a motor that drives the pump, and a controller that controls the motor. The automated driving vehicle has an automatic stop function that automatically stops the vehicle body by controlling the brake via the pump, with the controller controlling the motor. The automated driving vehicle includes a solenoid valve unit that includes an input port connected to an input oil passage connected to the pump and an output port connected to an output oil passage connected to the brake. The solenoid valve unit is switchable, based on a signal from the controller, between a connection state in which connection between the output port and the input port is not shut off and a checked state in which inflow of the hydraulic oil from the output port to the input port is restricted while outflow of the hydraulic oil from the input port to the output port is allowed.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating a forklift;

FIG. 2 is a block diagram illustrating a configuration of a controller;

FIG. 3 is a diagram illustrating a hydraulic circuit of a brake device;

FIG. 4 is a diagram illustrating the hydraulic circuit of the brake device;

FIG. 5 is a timing chart illustrating changes in a motor, a solenoid on-off valve, and a brake pressure;

FIG. 6 is a timing chart illustrating changes in the motor, the solenoid on-off valve, and the brake pressure; and

FIG. 7 is a diagram illustrating a hydraulic circuit of a brake device in a modification.

### DETAILED DESCRIPTION OF THE EMBODIMENTS

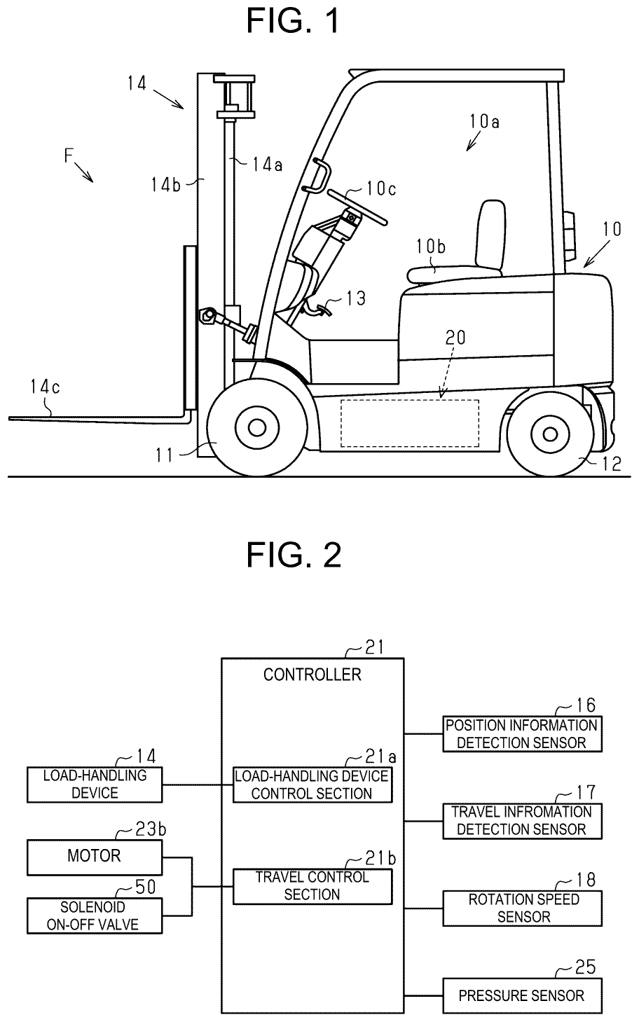

Hereinafter, an embodiment in which an automated driving vehicle is embodied as a forklift serving as an industrial vehicle will be described with reference to FIGS. 1 to 6. In the following description, “front”, “rear”, “upper”, and “lower” refer to “front”, “rear”, “upper”, and “lower” based on a state in which an operator who drives a forklift is facing the forward direction of the forklift.

### Overall Configuration of Forklift

An overall configuration of a forklift F will be described with reference to FIGS. 1 to 3.

The forklift F includes a vehicle body 10, drive wheels 11 disposed in the front of the vehicle body 10 and serving as wheels, a steering wheel 12 disposed in the rear of the vehicle body 10, and a brake pedal 13. The forklift F further includes a load-handling device 14, a brake device 20, and a battery (not illustrated). Therefore, the forklift F includes the vehicle body 10 equipped with the load-handling device 14. The forklift F is a counterbalanced forklift. The forklift F is capable of manned driving by an operator and unmanned automated driving.

The load-handling device 14 is provided in front of the vehicle body 10 and includes a lift cylinder 14a, a mast 14b, and a pair of forks 14c. The lift cylinder 14a is a hydraulic cylinder. The mast 14b extends in the vertical direction and moves up and down by the extension and contraction of the lift cylinder 14a. The pair of forks 14c is movable up and down together with the mast 14b. Goods (not illustrated) are loaded on the pair of forks 14c.

The drive wheels 11 are connected to a travel motor (not illustrated) and the brake device 20. The drive wheels 11 are rotated by the travel motor, and its braking is controlled by the brake device 20.

The battery (not illustrated) supplies electric power to the travel motor, a load-handling motor (not illustrated) included in the load-handling device 14, and the brake device 20.

The forklift F is provided with a cab 10a for manned driving. The cab 10a is provided with a driver's seat 10b on which the operator sits. The cab 10a is provided with a steering wheel 10c for driving, an accelerator pedal (not illustrated), and a brake pedal 13, and is also provided with a plurality of levers (not illustrated) for operating the load-handling device 14. During manned driving, the operator operates the steering wheel 10c to steer the steering wheel 12, and the operator operates the accelerator pedal to drive the travel motor.

### Controller

The forklift F can execute automated driving control. The automated driving is a driving mode in which the forklift F travels and stops according to, for example, an instruction from an operation management system or the like or a preset operation plan. The forklift F has an automatic stop function.

The forklift F includes a controller 21. The automated driving of the forklift F is controlled by the controller 21 illustrated in FIG. 2. The controller 21 includes a processor (not illustrated) and a storage. The processor included in the controller 21 is, for example, a central processing unit (CPU) or a micro-processing unit (MPU). The storage included in the controller 21 is, for example, a read-only memory (ROM) or a random-access memory (RAM). The processor included in the controller 21 executes a command included in a program stored in the storage to function as a load-handling device control section 21a and a travel control section 21b, which will be described later. It is noted that the controller 21 may include a plurality of electronic units.

The controller 21 is electrically connected to a position information detection sensor 16, a travel information detection sensor 17, a rotation speed sensor 18, and a pressure sensor 25.

The position information detection sensor 16 is a detector that detects the position of the forklift F. For example, the position information detection sensor 16 detects the position information of the forklift F by detecting an address of a magnetic marker or the like provided on the travel path in advance. The magnetic marker is provided, for example, at a position where the forklift F stops and performs load-handling work. The magnetic marker may be provided in front of the stop position so that the position information detection sensor 16 can detect that the forklift F is approaching the stop position during the travel of the forklift F. It is noted that the position information detection sensor 16 is an information processing device that includes a camera or a laser sensor and stores map data of the travel path, and may detect the position information of the forklift F using simultaneous localization and mapping (SLAM) or other methods.

The travel information detection sensor 17 detects the travel information of the forklift F. The travel information is, for example, the vehicle speed and acceleration of the forklift F. The travel information detection sensor 17 is provided in, for example, the travel motor and detects the rotation speed of the travel motor to detect the vehicle speed and acceleration of the forklift F.

The controller 21 includes the load-handling device control section 21a and the travel control section 21b. The controller 21 is connected to the load-handling device 14. The load-handling device control section 21a controls the load-handling device 14 based on the position information detected by the position information detection sensor 16. Specifically, when the position of the forklift F detected by the position information detection sensor 16 becomes a position where the load-handling work is performed, the load-handling device control section 21a causes the load-handling device 14 to perform the load-handling work at the position.

The travel control section 21b controls the travel of the forklift F based on position information and travel information detected by the position information detection sensor 16 and the travel information detection sensor 17. The travel control section 21b controls the steering wheel 12 based on the position information detected by the position information detection sensor 16.

The rotation speed sensor 18 measures the rotation speed of the drive wheels 11. For example, when the number of times the drive wheels 11 rotate per unit time is defined as the “rotation speed”, the rotation speed sensor 18 measures the number of rotations of the drive wheels 11. The rotation speed sensor 18 measures the rotation speed of the drive wheels 11 and transmits the measured rotation speed to the controller 21.

### Brake Device

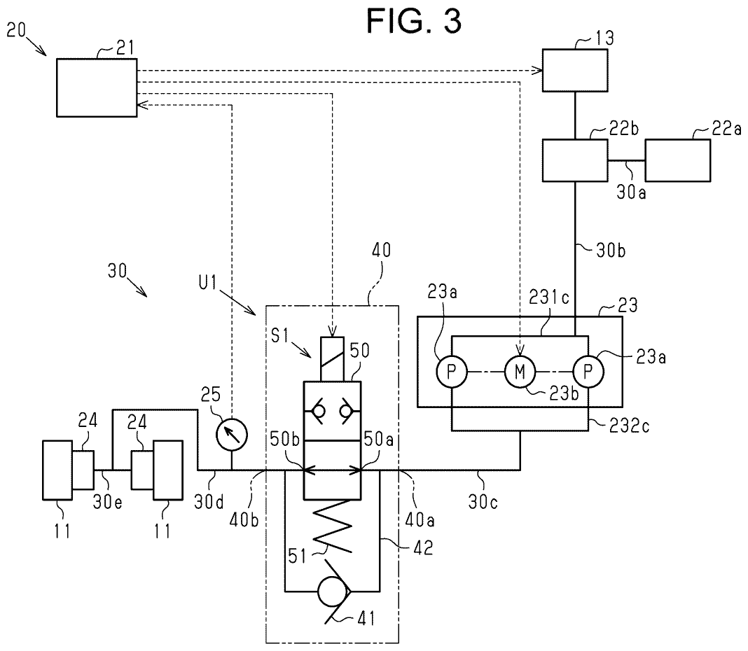

As illustrated in FIGS. 1 and 3, the forklift F includes the brake device 20 that controls the braking of the drive wheels 11. The brake device 20 includes a hydraulic oil tank 22a, a master cylinder 22b, a hydraulic actuator 23, and a pair of drum brakes 24 serving as a brake. The brake device 20 includes the pressure sensor 25 and a solenoid valve unit 40.

### Hydraulic Circuit

The brake device 20 includes a hydraulic circuit 30. The hydraulic circuit 30 is formed by a plurality of pipes connecting the hydraulic oil tank 22a, the master cylinder 22b, the hydraulic actuator 23, the solenoid valve unit 40, and the paired drum brakes 24. Hydraulic oil flows through each of the plurality of pipes included in the hydraulic circuit 30. Hydraulic oil is filled inside each of the pipes constituting the hydraulic circuit 30. In the present embodiment, the flow of the hydraulic oil means that the position of the hydraulic oil in the pipe slightly shifts due to compression of the entire hydraulic oil by external force.

The hydraulic circuit 30 includes a first oil passage 30a, a second oil passage 30b, an input oil passage 30c, an output oil passage 30d, and a third oil passage 30e. The first oil passage 30a connects the hydraulic oil tank 22a to the master cylinder 22b. The second oil passage 30b connects the master cylinder 22b to the hydraulic actuator 23. The input oil passage 30c connects the hydraulic actuator 23 to the solenoid valve unit 40. The output oil passage 30d connects the solenoid valve unit 40 to the third oil passage 30e. The third oil passage 30e is connected to each of the paired drum brakes 24.

The hydraulic oil tank 22a is a container that stores hydraulic oil. The hydraulic oil tank 22a stores hydraulic oil. The master cylinder 22b is connected to the hydraulic oil tank 22a and is coupled to the brake pedal 13. The master cylinder 22b pumps hydraulic oil to the paired drum brakes 24 in response to an input from the brake pedal 13. It is noted that the hydraulic oil tank 22a and the master cylinder 22b may be configured as an integrated unit.

### Hydraulic Actuator

The hydraulic actuator 23 includes two pumps 23a and a motor 23b. The two pumps 23a and the motor 23b constitute the hydraulic actuator 23. The pumps 23a and the motor 23b are integrated as a hydraulic actuator 23.

Inside the hydraulic actuator 23, a first pump oil passage 231c and two second pump oil passages 232c are formed. The first pump oil passage 231c is connected to the second oil passage 30b. The first pump oil passage 231c branches inside the hydraulic actuator 23. The first pump oil passage 231c connects the second oil passage 30b to each of the two pumps 23a. That is, the pumps 23a are connected to the hydraulic oil tank 22a. The motor 23b is connected to the master cylinder 22b via the pumps 23a. That is, the master cylinder 22b is connected to each of the motor 23b and the hydraulic oil tank 22a. Each of the two pumps 23a is connected to the input oil passage 30c via the second pump oil passage 232c.

The motor 23b drives the two pumps 23a. The motor 23b drives each of the two pumps 23a so that the two pumps 23a operate in the same manner. It is noted that the two pumps 23a may operate independently of each other.

The two pumps 23a operate by driving the motor 23b to pump the hydraulic oil from the first pump oil passage 231c toward the second pump oil passage 232c. That is, the hydraulic actuator 23 drives the pumps 23a using the motor 23b to pump the hydraulic oil from the second oil passage 30b toward the input oil passage 30c. The motor 23b is electrically connected to the controller 21. The motor 23b operates based on a signal transmitted from the travel control section 21b. That is, the controller 21 controls the motor 23b. By controlling the drive of the motor 23b, the controller 21 can change the amount of hydraulic oil pumped from each of the two pumps 23a toward the second pump oil passage 232c. That is, by controlling the drive of the motor 23b, the controller 21 causes the hydraulic actuator 23 to pump the hydraulic oil from the second oil passage 30b toward the input oil passage 30c.

### Solenoid Valve Unit

The solenoid valve unit 40 includes a solenoid on-off valve 50 and a check valve 41. The solenoid valve unit 40 includes an input port 40a and an output port 40b. The input port 40a is connected to the input oil passage 30c. That is, the solenoid valve unit 40 is connected to the input oil passage 30c by the input port 40a. The output port 40b is connected to the output oil passage 30d. That is, the solenoid valve unit 40 is connected to the output oil passage 30d by the output port 40b. The solenoid valve unit 40 is connected to the hydraulic actuator 23 by an input oil passage 30c.

The solenoid on-off valve 50 includes a solenoid valve input port 50a and a solenoid valve output port 50b. The solenoid valve input port 50a is connected to an input oil passage 30c that passes through the input port 40a. That is, the solenoid on-off valve 50 is connected to the hydraulic actuator 23 by the input oil passage 30c. The solenoid valve output port 50b is connected to the output oil passage 30d that passes through the output port 40b. The solenoid on-off valve 50 includes a biasing member 51. For example, the biasing member 51 is a spring.

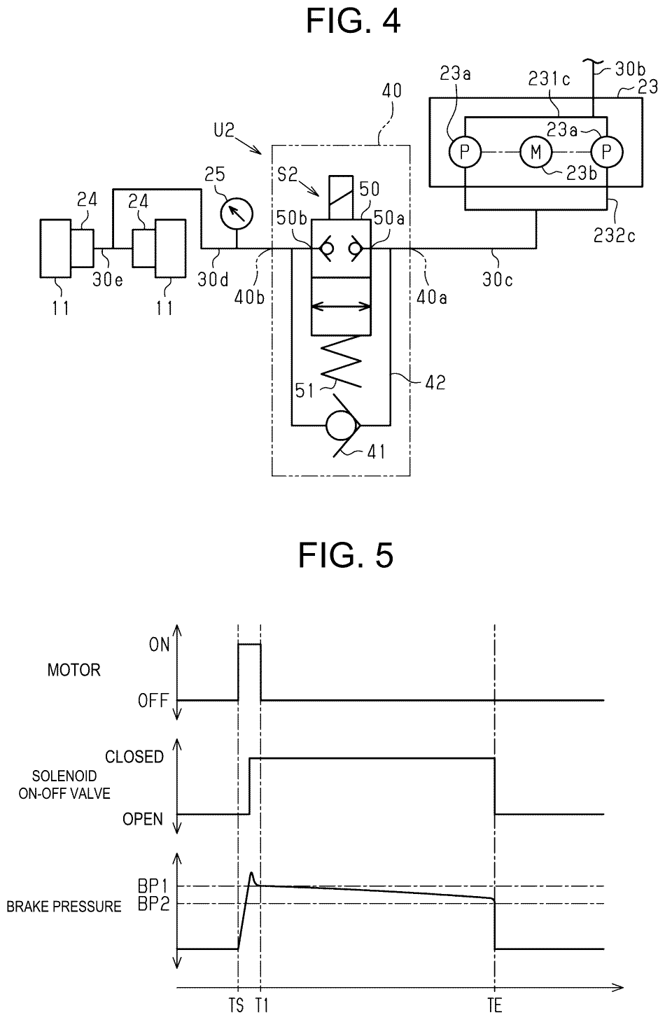

As illustrated in FIG. 3, the solenoid on-off valve 50 can be in an open state S1 in which the input oil passage 30c and the output oil passage 30d are not shut off. In other words, the solenoid on-off valve 50 in the open state S1 does not shut off the connection between the solenoid valve input port 50a and the solenoid valve output port 50b. As illustrated in FIG. 4, the solenoid on-off valve 50 can be in a closed state S2 in which the input oil passage 30c and the output oil passage 30d are shut off. In other words, the solenoid on-off valve 50 in the closed state S2 shuts off the connection between the solenoid valve output port 50b and the solenoid valve input port 50a. The biasing member 51 biases the solenoid on-off valve 50 in a direction to be in the open state S1.

As illustrated in FIG. 3, the solenoid on-off valve 50 is electrically connected to the controller 21. The solenoid on-off valve 50 operates based on a signal transmitted from the travel control section 21b. The solenoid on-off valve 50 is switchable between an open state S1 and a closed state S2 based on a signal transmitted from the controller 21. In other words, the solenoid on-off valve 50 is in one of the open state S1 or the closed state S2 based on a signal transmitted from the controller 21.

The solenoid valve unit 40 includes a branch oil passage 42. The branch oil passage 42 is connected to the input oil passage 30c at a first end. That is, the input oil passage 30c is connected to the first end of the branch oil passage 42 while being connected to the solenoid valve input port 50a. The branch oil passage 42 is connected to the output oil passage 30d at a second end. That is, the output oil passage 30d is connected to the second end of the branch oil passage 42 while being connected to the solenoid valve output port 50b. In other words, the first end of the branch oil passage 42 is connected to the input oil passage 30c and the second end of the branch oil passage 42 is connected to the output oil passage 30d. The branch oil passage 42 connects the input oil passage 30c to the output oil passage 30d without the solenoid on-off valve 50 being interposed.

The branch oil passage 42 is provided with the check valve 41. The check valve 41 allows the flow of the hydraulic oil from the first end toward the second end of the branch oil passage 42. The check valve 41 shuts off the flow of the hydraulic oil from the second end toward the first end of the branch oil passage 42. That is, in the branch oil passage 42, the check valve 41 allows the flow of the hydraulic oil from the input oil passage 30c toward the output oil passage 30d and shuts off the flow of the hydraulic oil from the output oil passage 30d toward the input oil passage 30c.

The solenoid valve unit 40 is switchable between a connection state U1 and a checked state U2. The connection state U1 is a state in which the input port 40a and the output port 40b communicate with each other in the solenoid valve unit 40. In other words, the solenoid valve unit 40 can be in the connection state U1 in which the connection between the output port 40b and the input port 40a is not shut off. When the solenoid valve unit 40 is in the connection state U1, the solenoid on-off valve 50 is in the open state S1.

The checked state U2 is a state in which the flow of the hydraulic oil from the output port 40b to the input port 40a is shut off while the flow of the hydraulic oil from the input port 40a to the output port 40b is allowed in the solenoid valve unit 40. In other words, the solenoid valve unit 40 can be in the checked state U2 in which the outflow of the hydraulic oil from the input port 40a to the output port 40b is allowed while the inflow of the hydraulic oil from the output port 40b to the input port 40a is prevented. When the solenoid valve unit 40 is in the checked state U2, the solenoid on-off valve 50 is in the closed state S2. In the checked state U2, the hydraulic oil in the input oil passage 30c is prevented from flowing from the output port 40b toward the input port 40a by the solenoid on-off valve 50. However, in the checked state U2, the hydraulic oil in the input oil passage 30c is not prevented from flowing from the input port 40a toward the output port 40b by the branch oil passage 42 and the check valve 41. In the checked state U2, the hydraulic oil in the output oil passage 30d is prevented from flowing from the output port 40b to the input port 40a by the solenoid on-off valve 50 and the check valve 41.

The controller 21 controls the state of the solenoid on-off valve 50 to control the state of the solenoid valve unit 40. More specifically, the controller 21 switches the solenoid on-off valve 50 from the closed state S2 to the open state S1 to switch the solenoid valve unit 40 from the checked state U2 to the connection state U1. The controller 21 switches the solenoid on-off valve 50 from the open state S1 to the closed state S2 to switch the solenoid valve unit 40 from the connection state U1 to the checked state U2. That is, the solenoid valve unit 40 is switchable based on a signal from the controller 21.

### Brake

Each of the paired drum brakes 24 is connected to the output oil passage 30d via a third oil passage 30e. Since the output oil passage 30d is connected to the solenoid valve unit 40, the paired drum brakes 24 are connected to the solenoid valve unit 40 via the output oil passage 30d. Each of the paired drum brakes 24 is connected to the drive wheels 11. Each of the paired drum brakes 24 converts the pressure generated by the hydraulic oil in the output oil passage 30d into braking force. The braking force is applied to the drive wheels 11. That is, each of the paired drum brakes 24 generates braking force on the drive wheels 11 of the vehicle body 10 in accordance with the pressure of the hydraulic oil.

### Pressure Sensor

The pressure sensor 25 is provided in the output oil passage 30d. The pressure sensor 25 measures the pressure generated by the hydraulic oil in the output oil passage 30d. In other words, the pressure sensor 25 measures the pressure of the hydraulic oil flowing through the output oil passage 30d. The pressure sensor 25 measures the pressure converted into the braking force by the paired drum brakes 24.

The pressure sensor 25 is electrically connected to the controller 21. The pressure sensor 25 transmits the pressure measured in the output oil passage 30d to the controller 21.

### Control by Controller

The forklift F has an automatic stop function that automatically stops the vehicle body 10 by controlling each of the paired drum brakes 24 via the pumps 23a, with the controller 21 controlling the motor 23b. The control of the brake device 20 by the controller 21 in a process in which the traveling forklift F decelerates and stops, and in a state where the traveling forklift F is stopped will be described with reference to FIGS. 1 to 6.

### Deceleration of Forklift

During the travel of the forklift F, the position information detection sensor 16 detects the position information of the forklift F on the travel path to detect that the stop position is approaching. The travel information detection sensor 17 detects the vehicle speed and acceleration of the forklift F. The stop position of the forklift F is, for example, a position where the forklift F performs load-handling work.

To stop at the stop position, the forklift F decelerates by the controller 21 controlling the brake device 20. Hereinafter, such operation is referred to as a deceleration operation.

To perform the deceleration operation, the travel control section 21b of the controller 21 calculates, based on the detected vehicle speed and acceleration, the braking force applied to the drive wheels 11 by each of the paired drum brakes 24 in order for the forklift F to stop at the stop position. Based on the calculation result, the travel control section 21b determines the amount of hydraulic oil supplied from the hydraulic actuator 23 to the drum brakes 24.

As illustrated in FIGS. 2 and 3, in the deceleration operation, the controller 21 causes the travel control section 21b to set the solenoid on-off valve 50 to the open state S1. That is, the solenoid on-off valve 50 connects the input oil passage 30c to the output oil passage 30d. At this time, the solenoid valve unit 40 is in the connection state U1. In the deceleration operation, the hydraulic actuator 23 drives the pumps 23a to pump the determined amount of hydraulic oil to each of the paired drum brakes 24 via the input oil passage 30c and the output oil passage 30d. Then, in accordance with the pressure of the hydraulic oil, braking force is generated on the drive wheels 11. This leads to deceleration of the vehicle body 10. As a result of the deceleration, the vehicle body 10 stops. The forklift F stops the vehicle body by the travel control section 21b controlling the drive of the motor 23b. That is, the forklift F has the automatic stop function that automatically stops the vehicle body 10 by controlling the drum brakes 24 via the pumps 23a, with the controller 21 controlling the drive of the motor 23b.

The calculation for determining the amount of hydraulic oil supplied to the drum brakes 24 by the travel control section 21b may be performed a plurality of times in accordance with changes in the vehicle speed and acceleration of the forklift F during the deceleration operation. In addition, the travel control section 21b may drive the motor 23b a plurality of times based on the result of the calculation performed a plurality of times during the deceleration operation. The travel control section 21b controls the motor 23b a plurality of times in accordance with changes in the vehicle speed and acceleration of the forklift F, thereby gradually decelerating the traveling forklift F.

### Stop Operation

After performing the deceleration operation, the forklift F stops at the stop position. The stop of the forklift F is detected by the travel information detection sensor 17, and the controller 21 operates to maintain the state in which the forklift F is stopped. Hereinafter, the operation is referred to as a stop operation.

FIG. 5 illustrates transitions of the operation of the motor 23b, the opening and closing of the solenoid on-off valve 50, and the pressure in the output oil passage 30d from the start to the end of the stop operation of the forklift F. The pressure in the output oil passage 30d illustrated in FIG. 5 is measured by the pressure sensor 25. Hereinafter, the pressure is referred to as brake pressure. In FIG. 5, the horizontal axis represents time. A time point at which the stop of the forklift F is detected by the travel information detection sensor 17 is defined as a stop start time point TS. A time point at which the forklift F ends the stop operation is defined as a stop end time point TE. The forklift F is stopped from the stop start time point TS to the stop end time point TE. The time from the stop start time point TS to the stop end time point TE is, for example, the time from when the forklift F starts the load-handling work to when the work is completed.

At the stop start time point TS, the controller 21 turns on the motor 23b to start the drive of the motor 23b. A time point at which the drive of the motor 23b ends and the motor 23b is turned off is defined as a motor stop time point T1. The time from the stop start time point TS to the motor stop time point T1 is shorter than the time from the stop start time point TS to the stop end time point TE. The time from the stop start time point TS to the motor stop time point T1 is about 1/100 times the time from the stop start time point TS to the stop end time point TE. In FIG. 5, the time from the stop start time point TS to the motor stop time point T1 is illustrated in an exaggerated manner.

The travel control section 21b causes the hydraulic actuator 23 to pump the hydraulic oil toward the output oil passage 30d via the solenoid on-off valve 50 from the stop start time point TS to the motor stop time point T1. The brake pressure increases with the pumping. The increase in the brake pressure leads to an increase in the braking force applied to the drive wheels 11 by each of the paired drum brakes 24. The controller 21 causes the travel control section 21b to stop the motor 23b when the value measured by the pressure sensor 25 is equal to or greater than a preset threshold.

It is noted that the preset threshold is referred to as a set pressure BP1. The set pressure BP1 is set to a brake pressure that enables load-handling work to be performed appropriately while the forklift F is stopped. The set pressure BP1 is determined in accordance with the environment in which the forklift F is used. The set pressure BP1 is determined based on, for example, a pipe defining the output oil passage 30d and the durability performance of the solenoid on-off valve 50.

As illustrated in FIG. 4, the travel control section 21b switches the solenoid on-off valve 50 from the open state S1 to the closed state S2. That is, the solenoid on-off valve 50 shuts off the input oil passage 30c and the output oil passage 30d. As illustrated in FIG. 5, the shut-off by the travel control section 21b is performed between the stop start time point TS and the motor stop time point T1. Even after the shut-off, the travel control section 21b drives the motor 23b until the motor stop time point T1.

Even after the solenoid on-off valve 50 enters the closed state S2, the brake pressure is slightly increased by the branch oil passage 42 until the motor stop time point T1. When the solenoid on-off valve 50 is switched from the open state S1 to the closed state S2, the pressure in the output oil passage 30d exceeds the set pressure BP1 due to the momentum imparted to the hydraulic oil by the solenoid on-off valve 50.

In a situation where the solenoid on-off valve 50 is in the closed state S2, the input oil passage 30c and the output oil passage 30d are connected such that the check valve 41 and the branch oil passage 42 allow the flow of the hydraulic oil from the input oil passage 30c to the output oil passage 30d. That is, the solenoid valve unit 40 is in the checked state U2.

During the stop operation, the travel control section 21b stops the motor 23b at the motor stop time point T1. The travel control section 21b maintains the state in which the motor 23b is stopped after the motor stop time point T1. After setting the solenoid on-off valve 50 to the closed state S2, the travel control section 21b maintains the closed state S2 of the solenoid on-off valve 50 until the stop end time point TE. Thus, the brake device 20 can maintain the brake pressure without driving the motor 23b. That is, the forklift F can continue applying the braking force to the drive wheels 11 by the paired drum brakes 24 while stopping the drive of the motor 23b.

At the stop end time point TE, the travel control section 21b switches the solenoid on-off valve 50 from the closed state S2 to the open state S1. When the solenoid on-off valve 50 enters the open state S1, the hydraulic oil which is restricted from flowing in the output oil passage 30d flows in the hydraulic circuit 30 in the direction from the paired drum brakes 24 to the hydraulic oil tank 22a. The brake pressure decreases due to the flow. Accordingly, the forklift F returns to a travelable state.

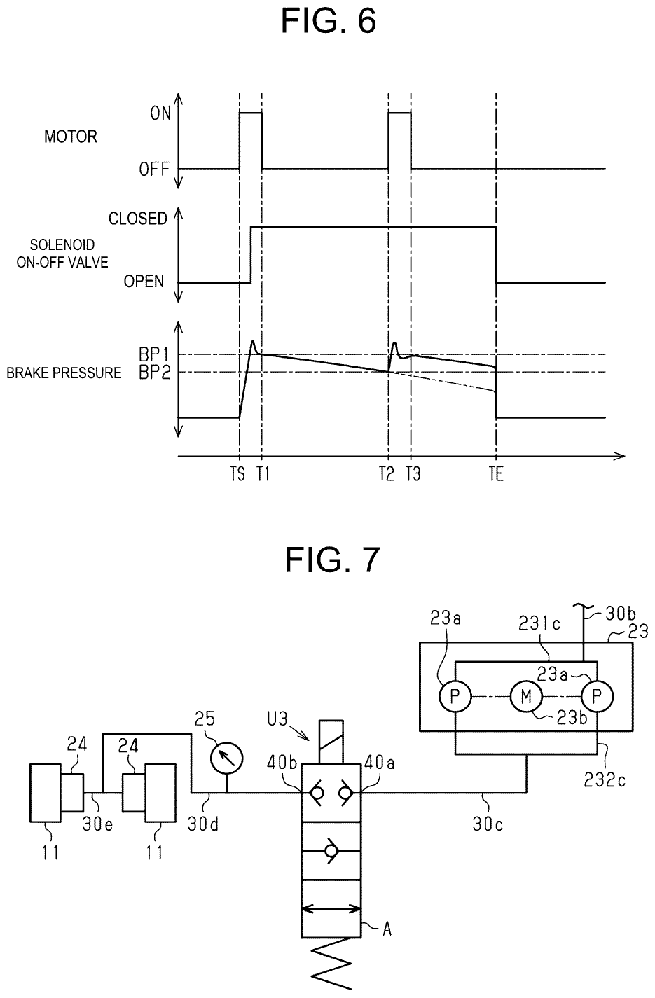

Even in a situation where the solenoid on-off valve 50 is in the closed state S2, the hydraulic oil slightly flows from the output oil passage 30d toward the input oil passage 30c. That is, as illustrated in FIGS. 5 and 6, when the forklift F is performing the stop operation, the brake pressure gradually decreases with the lapse of time. The lower limit value of the brake pressure required for maintaining the stop operation of the forklift F is referred to as a lower limit pressure BP2 serving as a predetermined pressure. The lower limit pressure BP2 is set based on the amount of hydraulic oil required to be pumped to the paired drum brakes 24 by the motor 23b to prevent the drive wheels 11 from rotating on a slope inclined at a predetermined angle. In the present embodiment, the predetermined angle is set in a range of 1.5° to 2.5°. At the time of setting the lower limit pressure BP2, it is preferable to provide a margin to prevent the forklift F from immediately moving on the slope inclined at the predetermined angle even if the brake pressure falls below the lower limit pressure BP2.

FIG. 6 illustrates a case where the brake pressure reaches the lower limit pressure BP2 while the forklift F is stopped. For example, deterioration of the solenoid on-off valve 50 may be cited as a factor that causes an increase in the drop of the brake pressure.

The controller 21 drives the motor 23b when the brake pressure becomes equal to or lower than the lower limit pressure BP2. A time point at which the motor 23b is driven again by the travel control section 21b between the stop start time point TS and the stop end time point TE is referred to as a motor re-drive time point T2. The motor re-drive time point T2 is between the stop start time point TS and the stop end time point TE. The motor re-drive time point T2 is a time point after the motor stop time point T1. The motor re-drive time point T2 is also a time point at which the brake pressure reaches the lower limit pressure BP2.

The travel control section 21b drives the motor 23b by the same length as the time from the stop start time point TS to the motor stop time point T1. A time point at which the re-drive of the motor 23b by the travel control section 21b ends is referred to as a motor re-stop time point T3. The time from the motor re-drive time point T2 to the motor re-stop time point T3 is equal to the time from the stop start time point TS to the motor stop time point T1.

When the brake pressure reaches the lower limit pressure BP2, the travel control section 21b drives the motor 23b at the motor re-drive time point T2 and stops the drive of the motor 23b at the motor re-stop time point T3 while keeping the solenoid on-off valve 50 in the closed state S2. During a period from the motor re-drive time point T2 to the motor re-stop time point T3, the motor 23b increases the brake pressure via the branch oil passage 42 and the check valve 41. As a result of the hydraulic oil being pumped by the hydraulic actuator 23 at the motor re-drive time point T2, the brake pressure exceeds the lower limit pressure BP2.

A two-dot chain line in FIG. 6 indicates the brake pressure when the motor 23b is not re-driven by the travel control section 21b. By driving the motor 23b at the motor re-drive time point T2, the forklift F maintains the stop without the brake pressure reaching the lower limit pressure BP2 from the stop start time point TS to the stop end time point TE.

### Control by Brake Pedal

The operation of the brake device 20 when the operator drives the forklift F will be described with reference to FIGS. 1 and 2.

When the forklift F is traveling under the operator's driving, the controller 21 sets the solenoid on-off valve 50 to the open state S1, as illustrated in FIG. 2.

When the operator steps on the brake pedal 13 to decelerate and stop the forklift F, the master cylinder 22b generates the pressure of the hydraulic oil by the force applied when the brake pedal 13 is depressed. The pressure converted by the master cylinder 22b is supplied to each of the paired drum brakes 24 by the hydraulic circuit 30. Thus, each of the paired drum brakes 24 applies braking force to the drive wheels 11. That is, the operator can control the braking of the forklift F by applying the braking force from the paired drum brakes 24 to the drive wheels 11 using the brake pedal 13.

### Operation of Present Embodiment

The operation of the present embodiment will be described.

The traveling forklift F decelerates and stops by the controller 21 controlling the drive of the motor 23b. During the deceleration and stopping, the controller 21 drives the motor 23b to pump the hydraulic oil from the hydraulic oil tank 22a toward the paired drum brakes 24. The pumping increases the brake pressure. The paired drum brakes 24 generate braking force on the drive wheels 11 in response to the pressure. By the braking force, the traveling forklift F decelerates and then stops. After the forklift F stops, the controller 21 switches the solenoid valve unit 40 to the checked state U2. When the solenoid valve unit 40 enters the checked state U2, the flow of the hydraulic oil in the output oil passage 30d into the input oil passage 30c is restricted.

Even when the solenoid valve unit 40 shuts off the input oil passage 30c from the output oil passage 30d, some flow of the hydraulic oil from the output oil passage 30d toward the input oil passage 30c occurs between the output oil passage 30d and the input oil passage 30c. In the checked state U2, the solenoid valve unit 40 can allow the flow of the hydraulic oil from the input oil passage 30c to the output oil passage 30d while restricting the inflow of the hydraulic oil from the output oil passage 30d to the input oil passage 30c. When the solenoid valve unit 40 is in the checked state U2, the controller 21 causes the motor 23b to pump the hydraulic oil from the hydraulic oil tank 22a toward the paired drum brakes 24.

### Effects of Present Embodiment

Effects of the present embodiment will be described.

(1) The forklift F controls the solenoid on-off valve 50 using the controller 21. The controller 21 switches the solenoid valve unit 40 to the checked state U2, thereby allowing the flow of the hydraulic oil from the input oil passage 30c to the output oil passage 30d while restricting the inflow of the hydraulic oil from the output oil passage 30d to the input oil passage 30c. Even when the brake pressure gradually decreases, the controller 21 can maintain the braking force applied to the drive wheels 11 by the paired drum brakes 24 through the intermittent drive of the motor 23b. The controller 21 controls the motor 23b and the solenoid valve unit 40 to maintain the stopped state of the forklift F by intermittently driving the motor 23b. As described above, the forklift F can shorten the time during which the motor 23b is driven with a simple configuration.

(2) The solenoid valve unit 40 includes the solenoid on-off valve 50 and the check valve 41 provided in the branch oil passage 42. In the solenoid valve unit 40, the controller 21 controls the connection between the output oil passage 30d and the input oil passage 30c only by opening and closing the solenoid on-off valve 50. That is, compared to a case where the connection of the branch oil passage 42 is also controlled in addition to the solenoid on-off valve 50, the controller 21 can control the connection between the output oil passage 30d and the input oil passage 30c by simpler control.

(3) The controller 21 can control the solenoid on-off valve 50 based on the result transmitted by the pressure sensor 25. In addition, the controller 21 can set in advance the lower limit pressure BP2 serving as the reference for driving the motor 23b. For example, when the controller 21 drives the motor 23b at regular time intervals, the controller 21 may drive the motor 23b in a situation where the braking force on the drive wheels 11 by the paired drum brakes 24 has not been reduced. However, when the controller 21 drives the motor 23b based on the measurement result of the pressure sensor 25, the forklift F can avoid excessive driving of the motor 23b. As described above, the forklift F can shorten the drive time of the motor 23b compared to a case where the pressure sensor 25 is not provided.

(4) Examples of the situation where the forklift F may start to move despite being stopped include a case where the forklift F is stopped on a slope. By setting the predetermined pressure as in the embodiment, the forklift F can maintain the stopped state even when the forklift F stops on the slope having the predetermined angle used for setting the predetermined pressure.

(5) In the forklift F, the pumps 23a and the motor 23b are integrated as the hydraulic actuator 23. In the forklift F, the brake device 20 can have a simpler configuration than a case where the pumps 23a and the motor 23b are not integrated.

(6) The forklift F may move without depending on a drive source such as an engine included in the forklift F, depending on the environment in which the forklift F is stopped. For example, the forklift F stopped on the slope may start to move along the slope due to gravity. For example, when the forklift F stopped on a slope starts to move along the slope, the controller 21 can detect the movement of the forklift F using the rotation speed sensor 18. In this case, the controller 21 causes the motor 23b to pump the hydraulic oil from the hydraulic oil tank 22a to the paired drum brakes 24 while setting the solenoid on-off valve 50 to the closed state S2. With the pumping, the paired drum brakes 24 apply, to the drive wheels 11, braking force required for the forklift F that has started to move along the slope to stop again. That is, when the solenoid on-off valve 50 is in the closed state S2, the controller 21 drives the motor 23b in accordance with the rotation speed of the drive wheels 11. Therefore, by including the rotation speed sensor 18, the forklift F can maintain the stop more accurately than a case where the forklift F does not include the rotation speed sensor 18.

(7) The forklift F can pump hydraulic oil toward the paired drum brakes 24 via the master cylinder 22b using the brake pedal 13. That is, by including the brake pedal 13 and the master cylinder 22b, the forklift F can decelerate and stop even through the operator's operation.

(8) The forklift F is required to stop more frequently than, for example, a normal automobile for the purpose of load handling. That is, the forklift F requires the drive of the motor 23b more frequently than, for example, a normal automobile. As a result, in the forklift F, it is desirable to shorten the time during which the motor 23b is driven. The forklift F can maintain the stopped state without driving the motor 23b using the solenoid on-off valve 50 and the check valve 41. Furthermore, even when the forklift F stops for a long time, the forklift F can maintain the braking force on the drive wheels 11 by the paired drum brakes 24 through the intermittent drive of the motor 23b. As described above, the drive time of the motor 23b can be shortened even in a situation where the forklift F is required to stop frequently.

### Modifications

It is noted that the above embodiment can be implemented with the following modifications. The above embodiment and the following modifications can be implemented in combination within a range not technically contradictory.

The controller 21 may be connected to the brake pedal 13 and automatically drive the brake pedal 13 to apply braking force to the drive wheels 11 via the master cylinder 22b. In this case, the brake pedal 13 is provided with a device that receives a signal transmitted from the controller 21 and converts the signal into the magnitude of the depression. Examples of the device include a potentiometer sensor.

The forklift F need not include the brake pedal 13 and the master cylinder 22b.

The forklift F need not include the rotation speed sensor 18. In this case, for example, the start of the movement of the vehicle body 10 may be detected based on the number of rotations of the travel motor detected by the travel information detection sensor 17. The start of the movement of the vehicle body 10 may be detected based on the speed of the vehicle body 10 detected by the travel information detection sensor 17.

The number of pumps 23a included in the hydraulic actuator 23 may be one. Alternatively, the number of pumps 23a included in the hydraulic actuator 23 may be three or more.

The pumps 23a and the motor 23b need not be integrated as the hydraulic actuator 23.

The lower limit pressure BP2 need not be determined based on the predetermined angle. The lower limit pressure BP2 may be determined based on the environment in which the forklift F is used or the performance of the forklift F.

The forklift F need not include the pressure sensor 25. In this case, the lower limit pressure BP2 need not be set. For example, the motor re-drive time point T2 may be after a lapse of a certain time from the stop start time point TS.

The interval between the stop start time point TS and the motor stop time point T1 may differ from the interval between the motor re-drive time point T2 and the motor re-stop time point T3. When the controller 21 re-drives the motor 23b after the motor stop time point T1, the difference between the brake pressure and the set pressure BP1 is equal to or less than the difference at the motor stop time point T1. That is, the interval between the motor re-drive time point T2 and the motor re-stop time point T3 may be shorter than the interval between the stop start time point TS and the motor stop time point T1. In this case, the forklift F can shorten the drive time of the motor 23b compared to a case where the interval between the stop start time point TS and the motor stop time point T1 is equal to the interval between the motor re-drive time point T2 and the motor re-stop time point T3.

The solenoid valve unit 40 need not include the solenoid on-off valve 50, the check valve 41, and the branch oil passage 42. For example, the solenoid valve unit 40 may be one solenoid valve switchable between the connection state U1 and the checked state U2.

As illustrated in FIG. 7, a solenoid valve unit A may be a solenoid valve that is switchable to a shut-off state U3 in which the connection between the output oil passage 30d and the input oil passage 30c is shut off based on a signal from the controller 21. That is, the solenoid valve unit A is switchable among the connection state U1, the checked state U2, and the shut-off state U3 based on a signal from the controller 21. In this case, when the forklift F performs deceleration operation, the controller 21 sets the solenoid valve unit A to the connection state U1. When the forklift F performs stop operation, the controller 21 sets the solenoid valve unit A to the shut-off state U3. In the stop operation, when the brake pressure reaches the lower limit pressure BP2, the controller 21 sets the solenoid valve unit A to the checked state U2. That is, the controller 21 switches the solenoid valve unit A from the shut-off state U3 to the checked state U2 at the motor re-drive time point T2. The controller 21 switches the solenoid valve unit 40 from the checked state U2 to the shut-off state U3 at the motor re-stop time point T3.

The brake need not be the paired drum brakes 24. For example, the brake may be a pair of disc brakes.

The automated driving vehicle is not limited to the forklift F. For example, the automated driving vehicle may be an industrial vehicle other than the forklift F or may be a normal automobile.

What is claimed is:

1. An automated driving vehicle comprising:
a vehicle body;
a hydraulic oil tank in which hydraulic oil is stored;
a brake that generates braking force on a wheel of the vehicle body in accordance with pressure of the hydraulic oil;
a pump connected to the hydraulic oil tank;
a motor that drives the pump; and
a controller that controls the motor,
the automated driving vehicle having an automatic stop function that automatically stops the vehicle body by controlling the brake via the pump, with the controller controlling the motor, wherein
the automated driving vehicle includes a solenoid valve unit that includes an input port connected to an input oil passage connected to the pump and an output port connected to an output oil passage connected to the brake, and
the solenoid valve unit is switchable, based on a signal from the controller, between a connection state in which connection between the output port and the input port is not shut off and a checked state in which inflow of the hydraulic oil from the output port to the input port is restricted while outflow of the hydraulic oil from the input port to the output port is allowed.

2. The automated driving vehicle according to claim 1, wherein
the solenoid valve unit includes:
a solenoid on-off valve including a solenoid valve input port connected to the input oil passage and a solenoid valve output port connected to the output port;
a branch oil passage having a first end connected to the input oil passage and a second end connected to the output oil passage; and
a check valve provided in the branch oil passage,
the solenoid on-off valve is switchable, based on a signal from the controller, between a closed state in which connection between the solenoid valve output port and the solenoid valve input port is shut off and an open state in which the connection between the solenoid valve output port and the solenoid valve input port is not shut off, and
the check valve allows outflow of the hydraulic oil from the input oil passage toward the output oil passage in the branch oil passage, and shuts off inflow of the hydraulic oil from the output oil passage toward the input oil passage.

3. The automated driving vehicle according to claim 1, wherein
the output oil passage is provided with a pressure sensor that measures pressure of the hydraulic oil flowing through the output oil passage and transmits the pressure to the controller, and
the controller drives the motor when the pressure becomes equal to or lower than a predetermined pressure.

4. The automated driving vehicle according to claim 3, wherein the predetermined pressure is set based on an amount of the hydraulic oil required to be pumped to the brake by the motor to prevent the wheel from rotating on a slope inclined at a predetermined angle.

5. The automated driving vehicle according to claim 1, wherein the pump and the motor are integrated as a hydraulic actuator.

6. The automated driving vehicle according to claim 2, further comprising a rotation speed sensor that measures a rotation speed of the wheel and transmits the rotation speed to the controller, wherein
the controller drives the motor in accordance with the rotation speed when the solenoid on-off valve is in the closed state.

7. The automated driving vehicle according to claim 1, further comprising:
a master cylinder; and
a brake pedal, wherein
the master cylinder is connected to each of the motor and the hydraulic oil tank, and
the brake pedal is provided on the vehicle body and is coupled to the master cylinder.

8. The automated driving vehicle according to claim 1, wherein the solenoid valve unit is switchable, based on a signal from the controller, to a shut-off state in which the output port and the input port are shut off.

9. The automated driving vehicle according to claim 1, wherein the automated driving vehicle is an industrial vehicle including a load-handling device.
